(19) United States
(12) Patent Application Publication
(10) Pub. No.: US 2026/0048692 A1
(43) Pub. Date: Feb. 19, 2026

(54) MANUAL FOUR-WAY HEADREST

(71) Applicant: Adient (Chongqing) Automotive Components Co., Ltd., Chongqing (CN)

(72) Inventors: Zhongren HU, Chongqing (CN); Xingyuan DENG, Chongqing (CN)

(21) Appl. No.: 19/302,146

(22) Filed: Aug. 18, 2025

(30) Foreign Application Priority Data
Aug. 19, 2024 (CN) 202411134077.8

(51) Int. Cl. B60N 2/818; B60N 2/815; B60N 2/865

(52) U.S. Cl. CPC B60N 2/818; B60N 2/815; B60N 2/865

(57) ABSTRACT

A manual four-way headrest may have a headrest rod. The headrest may also have an inner pad block, which is fitted around the headrest rod so as to be able to slide vertically. The headrest may also have a support component, which is provided with a guide post that extends in the front-rear direction of the headrest. The headrest may also have a headrest body, which is fixedly mounted on a front end of the support component. The headrest may also have a locking mechanism; the locking mechanism may have a locking strip that is slidably mounted along a width direction of the inner pad block. The headrest may also have an elastic element that is between the locking strip and the inner pad block, and an unlocking button that controls the sliding of the locking strip.

### TECHNICAL FIELD

The present utility model relates to the technical field of automotive parts, in particular to a manual four-way headrest.

### BACKGROUND ART

With the popularity of automobiles in daily life, the safety and riding comfort of vehicles are increasingly important for consumers; in order to support the head of an occupant, alleviate riding fatigue, or protect the head and neck of an occupant, according to different statures and body postures of occupants, not only does the headrest need to be adjusted to a suitable height, but also the headrest needs to be adjusted to a suitable front-rear position, to ensure riding comfort and safety, and hence most automobile headrests at present are four-way.

Four-way headrests divide into two types: electric adjustment and manual adjustment. At present, the manual four-way headrest is controlled by different locking mechanisms for height adjustment and front-rear adjustment thereof, and consequently has disadvantages of a complicated internal structure, a large number of parts and poor assembly convenience; moreover, it is also troublesome for a user to adjust the headrest manually.

### SUMMARY OF THE UTILITY MODEL

In view of this, the present utility model provides a manual four-way headrest, the objective of which is to solve the problem of the structural complexity of the conventional manual four-way headrest.

To achieve the abovementioned objective, technical solutions of the present utility model are as follows:

A manual four-way headrest, comprising:
a headrest rod, which is used for fixedly connecting to an upper end of a backrest;
an inner pad block, which is fitted around the headrest rod so as to be able to slide vertically, the inner pad block being provided with a first mounting hole that passes through the headrest in a front-rear direction;
a support component, which is provided with a guide post that extends in the front-rear direction of the headrest, the guide post being fitted in the first mounting hole so as to be able to slide forward and backward;
a headrest body, which is fixedly mounted on a front end of the support component; and
a locking mechanism, the locking mechanism comprising a locking strip that is slidably mounted along a width direction of the inner pad block, an elastic element that is disposed between the locking strip and the inner pad block, and an unlocking button that controls the sliding of the locking strip, and the locking strip having a first locking part and a second locking part; under an elastic force of the elastic element, the first locking part and the second locking part can be locked on the guide post and the headrest rod, respectively, to limit the forward-backward sliding of the guide post and the vertical sliding of the inner pad block; pressing the unlocking button can push the locking strip to slide, to remove the movement restriction of the first locking part and the second locking part on the guide post and the inner pad block.

With the above structure, three-part insertion cooperation of the headrest rod, the inner pad block and the support component can constitute four-way adjustment, and the cost is low, and the structure is simple; four-way locking is achieved by the locking strip, and the adjustment is convenient.

Preferably: the support component is provided with a mounting plate at the front end and the guide post extending horizontally rearwardly at a rear end, the first locking part being a toothed structure that is arranged on the locking strip, and the guide post being provided with a rack that engages with the toothed structure. With the above structure, by means of engagement of the toothed structure, front-rear adjustment of the headrest is achieved, and the adjustment is stable and convenient.

Preferably: the second locking part is a strip-shaped protrusion that is arranged on the locking strip, and a strip-shaped slot that matches the strip-shaped protrusion is distributed in an array on the headrest rod. With the above structure, the adjustment is stable and convenient, and a degree of shaking of the headrest is small.

Preferably: the locking strip is provided with a second mounting hole that passes through the headrest in a vertical direction, the headrest rod being mounted in the second mounting hole, the second locking part being located in a sidewall of the second mounting hole that is remote from the unlocking button, the number of guide posts provided being 4, which are mounted vertically symmetrically with respect to the locking strip, an upper side of the locking strip being provided with a clearance slot, the guide post above the locking strip being mounted inside the clearance slot, and the first locking part being located on a sidewall of the clearance slot that is remote from the unlocking button. With the above structure, installation is convenient and compact.

Preferably: a rear end of the guide post is provided with a first limiting catch, and, when the headrest body is adjusted to a foremost position, the first limiting catch catches the inner pad block. With the above structure, a front-rear adjustment range of the headrest is limited.

Preferably: an upper end of the headrest rod is provided with a locking pin that is inserted perpendicular to the axis, a length of the locking pin being larger than a diameter of the headrest rod, the inner pad block being provided with a sliding slot in a height direction, and the locking pin cooperating with the sliding slot for limiting a vertical adjustment distance of the headrest body. With the above structure, the structure is simple, and a vertical adjustment range of the headrest is limited.

Preferably: the elastic element is a return spring, and the return spring is mounted between the locking strip and the inner pad block, and is used for resetting the locking strip. With the above structure, when the headrest is adjusted to a suitable position, releasing the button can immediately lock the button, and the structure is simple and the cost is low.

Preferably: the unlocking button comprises a button and a button holder, a side face of the button holder that directly faces the locking strip being fixedly mounted on a rear cover, the button being mounted on the button holder, and abutting the locking strip, an end face of the locking strip that is near the unlocking button being provided with an elongated part in a width direction, the elongated part being used for preventing the button from being unable to abut the side face of the locking strip after front-rear adjustment of the headrest body, the button being provided with a pair of upper and lower abutting posts, the two abutting posts being used for preventing the button from being unable to abut the side face of the locking strip after vertical adjustment of the headrest body. With the above structure, it is ensured that the button abuts the locking strip, and the adjustment is convenient.

Preferably: a spring piece is mounted in a gap between the guide post and the inner pad block, and the spring piece is used for compensating for the mounting gap. With the above structure, adjustment is smooth, and a degree of shaking of the headrest is small.

Preferably: an end face of the locking strip that is remote from the unlocking button is provided with a second limiting catch, and, when the locking strip is reset, the second limiting catch catches the inner pad block. With the above structure, damage to the locking part is prevented.

The beneficial effects of the present utility model compared to the prior art are:

1. Three-part insertion cooperation of the headrest rod, the inner pad block and the support component can constitute four-way adjustment, and there are technical advantages of low cost, simple and compact structure, and convenient mounting. Moreover, on the basis of this structure, locking and unlocking of the forward, rearward, upward and downward four-way adjustment of the headrest are realized by means of a locking mechanism alone; compared to conventional manual four-way adjustment, the operation is convenient and the user experience is significantly improved.

2. A larger adjustment range is provided, and vertical and front-rear adjustment are both provided with a limiting assembly, which ensures adjustment safety while satisfying various requirements.

3. Mounting the spring piece compensates for a mounting gap, so that the adjustment is stable, and a degree of headrest shaking is small.

### BRIEF DESCRIPTION OF THE DRAWINGS

FIG. 1 is an exploded view of the present utility model;

FIG. 2 is a schematic drawing of the internal structure of the present utility model;

FIG. 3 is a schematic drawing of the external structure of the present utility model;

FIG. 4 is a schematic drawing showing a first locking part 09;

FIG. 5 is a schematic drawing showing a second locking part 10;

FIG. 6 is a schematic drawing showing a first catch 02d and a spring piece 14;

FIG. 7 is a schematic drawing showing a second catch 07d;

FIG. 8 is a schematic drawing showing a button 11;

FIG. 9 is a schematic drawing showing the structure of a locking strip 07.

### DETAILED DESCRIPTION OF EMBODIMENTS

The present utility model is explained further below with reference to the embodiments and accompanying drawings.

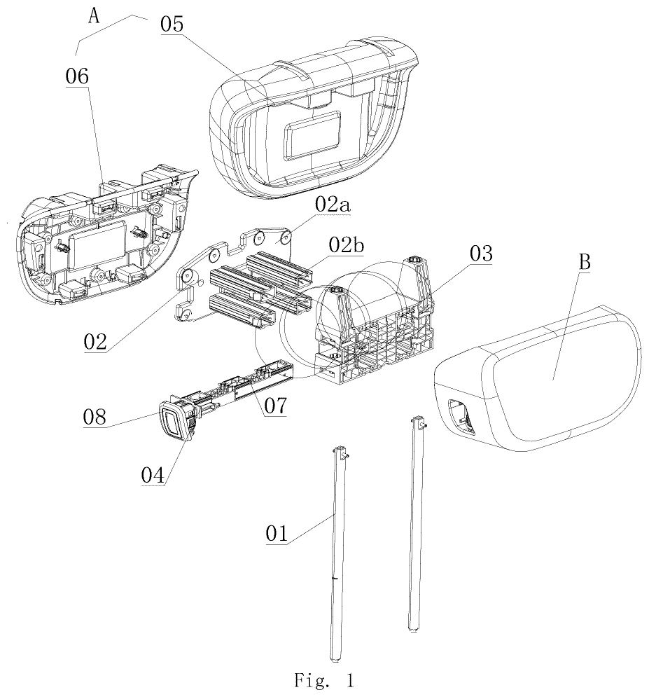

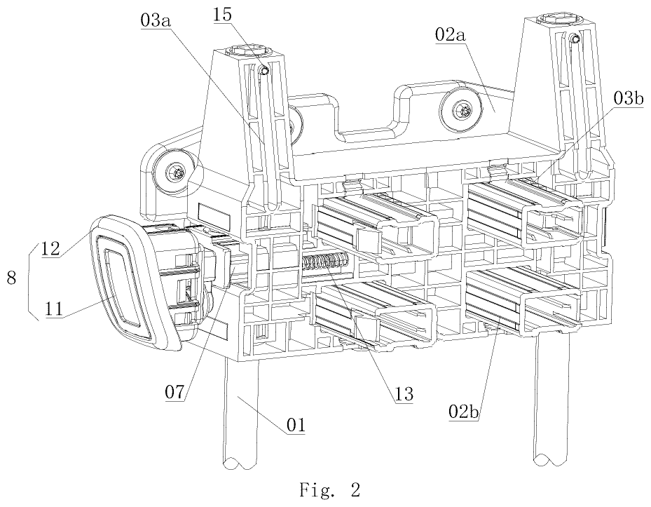

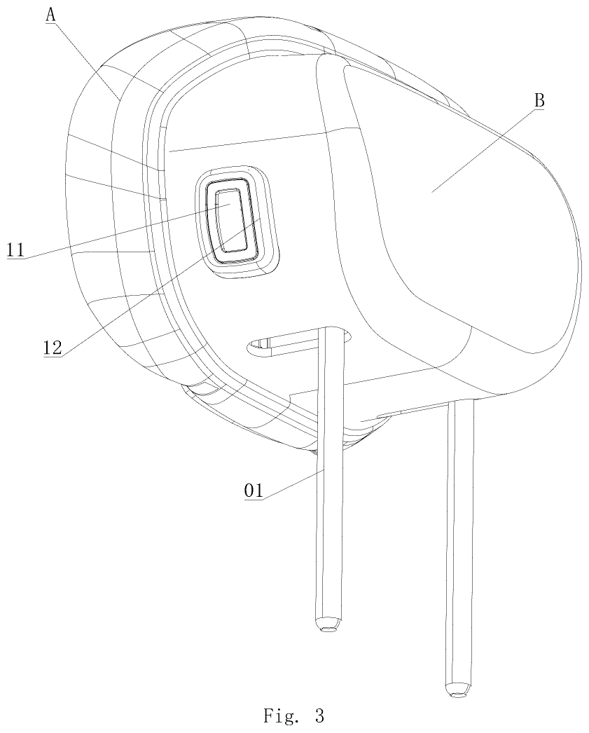

FIGS. 1 and 3 show a manual four-way headrest, wherein a core member of the headrest mainly relates to a headrest rod 01, a support component 02, an inner pad block 03, a locking mechanism 04 and a headrest body A. A lower part of the headrest rod 01 is used for fixed connection to an upper end of a backrest of an automobile seat. As can be seen from FIG. 2, the inner pad block 03 resembles a rectangular block-like structure, the left and right ends of which are fitted around the headrest rods 01 so as to be able to slide vertically, and a lower portion of the inner pad block 03 is provided with first mounting holes 03b that pass through the headrest in a front-rear direction. A rear portion of the support component 02 is provided with guide posts 02b that extend in a front-rear direction of the headrest, the number of guide posts 02b corresponding to the number of first mounting holes 03b, and the guide posts being slidably fitted in the first mounting holes 03b in one-to-one correspondence. In the present embodiment, referring to FIG. 1, the headrest body A consists of a support framework plate 06 and flexible foam 05 that covers a surface of the support framework plate 06, wherein the support framework plate 06 is fixedly mounted to the front end of the support component 02.

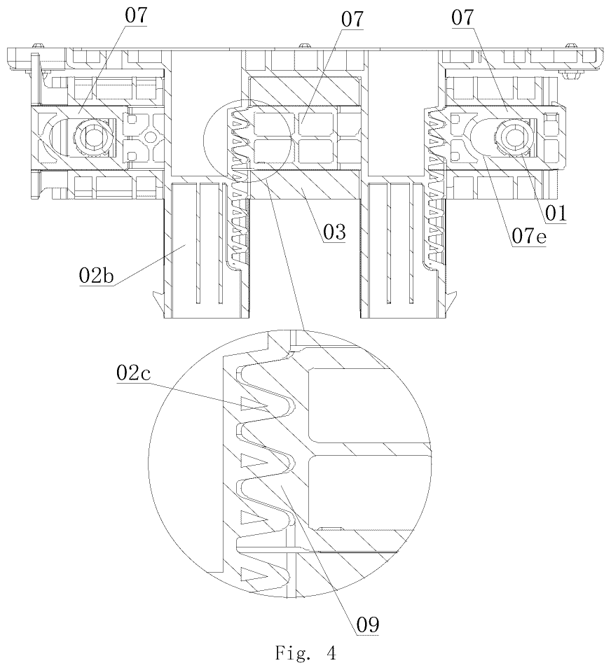

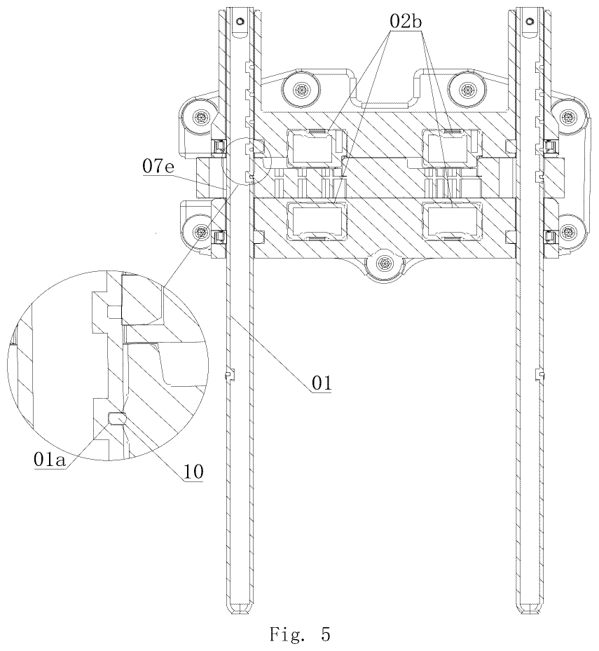

The locking mechanism 04 comprises a locking strip 07, an elastic element 13 and an unlocking button 08, the locking strip 07 being a rectangular elongated structure, as can be seen from FIGS. 2 and 4, and the locking strip 07 sliding through the inner pad block 03 in a width direction of the inner pad block 03. The elastic element 13 is arranged between the locking strip 07 and the inner pad block 03. The unlocking button 08 is mounted on a side of the headrest and is used to control the sliding of the locking strip 07. Referring again to FIG. 4, the locking strip 07 is provided with a first locking part 09 at a position corresponding to a portion of the guide post 02b, and referring again to FIG. 5, the locking strip 07 is provided with a second locking part 10 at a position corresponding to the headrest rod 01. In the present embodiment, the elastic element 13 is a return spring, mounted between the inner pad block 03 and the locking strip 07, for resetting the locking strip 07, and, under the elastic force of the elastic element 13, the first locking part 09 and the second locking part 10 can be locked to the guide post 02b and the headrest rod 01, respectively, to limit the forward-backward sliding of the guide post 02b and the vertical sliding of the inner pad block 03. Pressing the unlocking button 08 can push the locking strip 07 to slide to remove the movement restriction of the first locking part 09 and the second locking part 10 on the guide post 02b and the inner pad block 03, thereby achieving synchronous unlocking of height and front-rear adjustment of the headrest.

As shown in FIGS. 2 and 4, the support component 02 is provided with a mounting plate 02a at the front end and the guide post 02b extending horizontally rearwardly at a rear end, the first locking part 09 being a toothed structure that is arranged on the locking strip 07, and one side of the guide post 02b that is remote from the unlocking button 08 being provided with a rack 02c that engages with the toothed structure. In the locked state, the toothed structure of the locking strip 07 is engaged with the rack 02c, and, when unlocked, the toothed structure is away from the rack 02c.

As shown in FIGS. 2 and 5, the second locking part 10 is a strip-shaped protrusion that is arranged on the locking strip 07, and a strip-shaped slot 01a that engages with the strip-shaped protrusion is distributed in an array on one side of the headrest rod 01 that is remote from the unlocking button 08; in a locked state, the strip-shaped protrusion of the locking strip 07 is engaged with the strip-shaped slot 01a, and, when unlocked, the strip-shaped protrusion is away from the strip-shaped slot 01a.

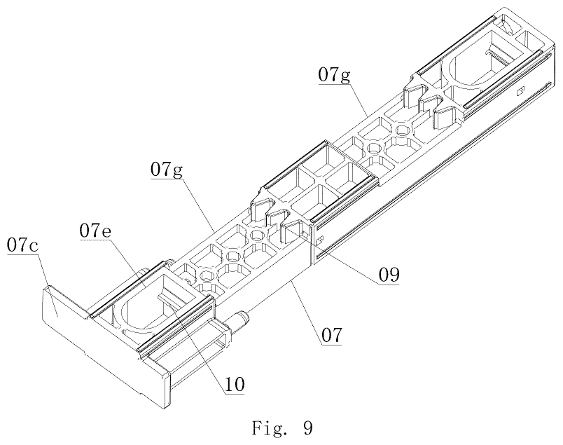

As shown in FIG. 9, the locking strip 07 is provided with a second mounting hole 07e that passes through the headrest in a vertical direction, the headrest rod 01 being mounted in the second mounting hole 07e, the second mounting hole 07e being widened to ensure sliding of the locking strip 07 is not obstructed, and the second locking part 10 being located on a sidewall of the second mounting hole 07e at a side that is remote from the unlocking button 08.

As shown in FIG. 5, the number of guide posts 02b is four, which are mounted vertically symmetrically with respect to the locking strip 07 and distributed in a rectangular shape, wherein two of the guide posts 02b are located on an upper side of the locking strip 07, and the other two are located on a lower side of the locking strip 07. As can be seen from FIG. 9, the upper side of the locking strip 07 is provided with two clearance slots 07g, and two guide posts 02b on the upper side of the locking strip 07 are located in the two clearance slots 07g, and the first locking part 09 is arranged on a sidewall of the clearance slot 07g at a side that is remote from the unlocking button 08. Three-part insertion cooperation of the headrest rod 01, the inner pad block 03 and the guide post 02b can constitute four-way adjustment, and the cost is low, and the structure is simple; four-way locking is achieved by the locking strip 07, and pressing the button 11 can adjust the headrest body A vertically and forward-backward simultaneously, and the adjustment is convenient.

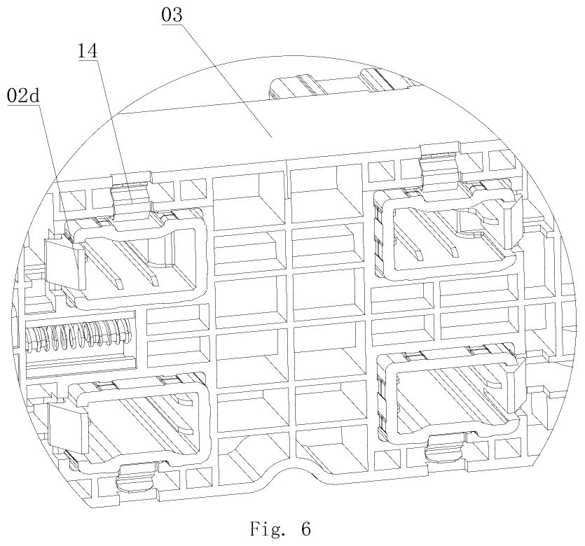

As shown in FIG. 6, each of the four guide posts 02b is provided at a rear end thereof with a first limiting catch 02d, and, the first limiting catch 02d catches the inner pad block 03 when the headrest body A is adjusted to the foremost position; in the present embodiment, a mounting plate 02a and the first limiting catch 02d cooperate to limit the front-rear adjustment range of the headrest body A.

A spring piece 14 is mounted in a gap between the guide post 02b and the inner pad block 03, and the spring piece 14 is used for compensating for the mounting gap, so that adjustment of the headrest is stable and a degree of shaking is small.

As shown in FIG. 2, an upper end of the headrest rod 01 is provided with a locking pin 15 that is inserted perpendicular to the axis, a length of the locking pin 15 being larger than a diameter of the headrest rod 01, the inner pad block 03 being provided with a sliding slot 03a in a height direction, and the locking pin 15 cooperating with the sliding slot 03a for limiting a vertical adjustment range of the headrest body A.

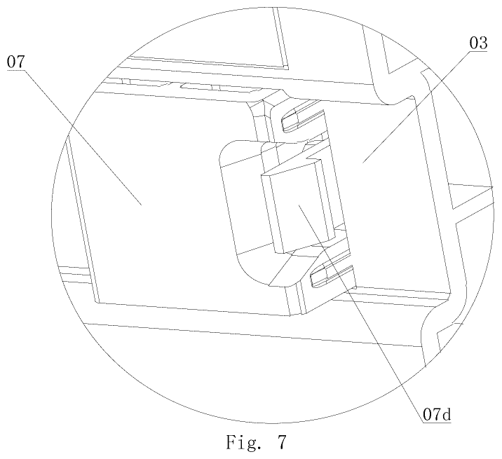

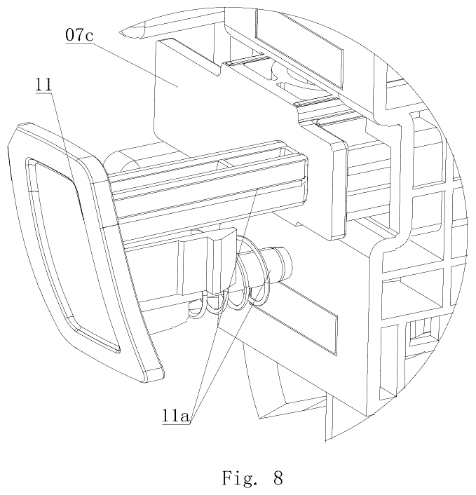

As shown in FIGS. 3, 7 and 8, the unlocking button 08 comprises a button 11 and a button holder 12, a side face of the button holder 12 that directly faces the locking strip 7 being fixedly mounted on a rear cover B, and the button 11 being mounted on the button holder 12, and abutting the locking strip 07; to ensure that the button 11 always abuts the side face of the locking strip 07 when the headrest body A is at any position, an end face of the locking strip 07 that is near the unlocking button 08 is provided with an elongated part 07c in a width direction, and the button 11 is provided with a pair of upper and lower abutting posts 11a, and a spring is fitted on the lower abutting post 11a for preventing the button 11 from catching and being difficult to reset when the lower abutting post 11a abuts the locking strip 07.

After pressing the button, the locking strip 07 slides in the length direction of the inner pad block 03, the first locking part 09 and the second locking part 10 are separated from the headrest rod 01 and the guide post 02b, respectively, and the headrest body A can be vertically and front-rear adjusted simultaneously; in the present embodiment, an end face of the locking strip 07 that is remote from the unlocking button 08 is provided with a second limiting catch 07d, and, when the locking strip 07 is reset, the second limiting catch 07d catches the inner pad block 03, preventing damage caused by wear transition of the first locking part 09 and the second locking part 10.

Finally, it should be noted that the foregoing merely describes preferred embodiments of the present utility model, and that those skilled in the art, under the teachings of the present utility model, without departing from the purpose and claims thereof, may make various similar representations, and such transformations all fall within the scope of protection of the present utility model.

What is claimed is:

1. A manual four-way headrest, comprising:
a headrest rod, which is used for fixedly connecting to an upper end of a backrest;
an inner pad block, which is fitted around the headrest rod so as to be able to slide vertically, the inner pad block being provided with a first mounting hole that passes through the headrest in a front-rear direction;
a support component, which is provided with a guide post that extends in the front-rear direction of the headrest, the guide post being fitted in the first mounting hole so as to be able to slide forward and backward;
a headrest body, which is fixedly mounted on a front end of the support component; and
a locking mechanism, the locking mechanism comprising a locking strip that is slidably mounted along a width direction of the inner pad block, an elastic element that is disposed between the locking strip and the inner pad block, and an unlocking button that controls the sliding of the locking strip, and the locking strip having a first locking part and a second locking part; under an elastic force of the elastic element, the first locking part and the second locking part can be locked on the guide post and the headrest rod, respectively, to limit the forward-backward sliding of the guide post and the vertical sliding of the inner pad block; pressing the unlocking button can push the locking strip to slide, to remove the movement restriction of the first locking part and the second locking part on the guide post and the inner pad block.

2. The manual four-way headrest as claimed in claim 1, wherein: the support component is provided with a mounting plate at the front end and the guide post extending horizontally rearwardly at a rear end, the first locking part being a toothed structure that is arranged on the locking strip, and the guide post being provided with a rack that engages with the toothed structure.

3. The manual four-way headrest as claimed in claim 1, wherein: the second locking part is a strip-shaped protrusion that is arranged on the locking strip, and a strip-shaped slot that matches the strip-shaped protrusion is distributed in an array on the headrest rod.

4. The manual four-way headrest as claimed in claim 1, wherein: the locking strip is provided with a second mounting hole that passes through the headrest in a vertical direction, the headrest rod being mounted in the second mounting hole, the second locking part being located in a sidewall of the second mounting hole that is remote from the unlocking button, the number of guide posts provided being four, which are mounted vertically symmetrically with respect to the locking strip, an upper side of the locking strip being provided with a clearance slot, the guide post above the locking strip being mounted inside the clearance slot, and the first locking part being located on a sidewall of the clearance slot that is remote from the unlocking button.

5. The manual four-way headrest as claimed in claim 1, wherein: a rear end of the guide post is provided with a first limiting catch, and, when the headrest body is adjusted to a foremost position, the first limiting catch catches the inner pad block.

6. The manual four-way headrest as claimed in claim 1, wherein: an upper end of the headrest rod is provided with a locking pin that is inserted perpendicular to the axis, a length of the locking pin being larger than a diameter of the headrest rod, the inner pad block being provided with a sliding slot in a height direction, and the locking pin cooperating with the sliding slot for limiting a vertical adjustment distance of the headrest body.

7. The manual four-way headrest as claimed in claim 1, wherein: the elastic element is a return spring, the return spring being mounted between the locking strip and the inner pad block, for resetting the locking strip.

8. The manual four-way headrest as claimed in claim 1, wherein: the unlocking button comprises a button and a button holder, a side face of the button holder that directly faces the locking strip being fixedly mounted on a rear cover, the button being movably mounted on the button holder, and abutting the locking strip, an end face of the locking strip that is near the unlocking button being provided with an elongated part in a width direction, the elongated part being used for preventing the button from being unable to abut the side face of the locking strip after front-rear adjustment of the headrest body, the button being provided with a pair of upper and lower abutting posts, the two abutting posts being used for preventing the button from being unable to abut the side face of the locking strip after vertical adjustment of the headrest body.

9. The manual four-way headrest as claimed in claim 1, wherein: a spring piece is mounted in a gap between the guide post and the inner pad block, and the spring piece is used for compensating for the mounting gap.

10. The manual four-way headrest as claimed in claim 1, wherein: an end face of the locking strip that is remote from the unlocking button is provided with a second limiting catch, and, when the locking strip is reset, the second limiting catch catches the inner pad block.
